(19) United States
(12) Patent Application Publication
(10) Pub. No.: US 2025/0100620 A1
(43) Pub. Date: Mar. 27, 2025

(54) METHOD AND APPARATUS FOR DETECTING ANOMALY IN LANE FOLLOWING ASSISTANCE SYSTEM

(71) Applicant: HL MANDO CORPORATION, Gyeonggi-do (KR)

(72) Inventors: Manki KIM, Gyeonggi-do (KR); Yonghyun CHO, Gyeonggi-do (KR); Jaegyu LEE, Gyeonggi-do (KR)

(21) Appl. No.: 18/828,105

(22) Filed: Sep. 9, 2024

(30) Foreign Application Priority Data
Sep. 27, 2023 (KR) 10-2023-0130784

(51) Int. Cl. B62D 15/02; G07C 5/08

(52) U.S. Cl. CPC B62D 15/025; G07C 5/0808; G07C 5/0816

(57) ABSTRACT

A method and apparatus for detecting an anomaly in a lane following assistance system perform one or more operations including receiving, by an electronic apparatus, a GPS signal of a running vehicle; checking, by the electronic apparatus, whether a road on which the vehicle is driving is straight by analyzing the GPS signal; accumulating, by the electronic apparatus, an anomaly determination count based on a steering control signal confirmed while driving on a straight road; and detecting, by the electronic apparatus, whether there is an anomaly in a lane following assistance system based on the accumulated anomaly determination count.

### CROSS-REFERENCE TO RELATED APPLICATION

This application claims priority to and the benefit from Korean Patent Application No. 10-2023-0130784, filed on Sep. 27, 2023, the disclosure of which is incorporated herein by reference in its entirety.

### TECHNICAL FIELD

The present disclosure generally relates to a method and apparatus for detecting an anomaly in a lane following assistance system.

### BACKGROUND

In recent years, research has been actively conducted on vehicles equipped with an advanced driver assistance system (ADAS) that actively provides information on vehicle condition, driver condition, and surrounding environment to alleviate the driver's burden and enhance convenience.

Among these advanced driver assistance systems, lane following assistance (LFA) and lane keeping assistance (LKA) that also apply to autonomous vehicles are functions that help drivers drive more safely.

In this case, the lane following assistance system refers to a driving convenience system that controls steering so that the vehicle can drive while maintaining the center of the road during autonomous driving. However, if there is an anomaly in the function of the lane following assistance system, the vehicle cannot accurately maintain the center of the lane and the vehicle shakes left/right, causing inconvenience such as motion sickness.

In this way, when an inconvenience occurs due to an anomaly in the lane following assistance system while driving, the driver visits the repair shop and solves the problem by using methods such as calibration of the front camera, wheel alignment, and air pressure check. However, until now, it is common to visit the repair shop only after the driver experiences inconvenience because it does not provide guidance on the timing of maintenance of the lane following assistance system.

### SUMMARY

In order to solve such a conventional problem, some embodiments of the present disclosure are directed to providing a method and apparatus for detecting an anomaly in a lane following assistance system capable of checking whether a road on which a vehicle is driving is straight based on a GPS signal and detecting an anomaly in the lane following assistance system based on a steering angle obtained from a vehicle driving on a straight road.

A method for detecting an anomaly in a lane following assistance system according to an embodiment of the present disclosure includes: receiving, by an electronic apparatus, a GPS signal of a running vehicle; checking, by the electronic apparatus, whether a road on which the vehicle is driving is straight by analyzing the GPS signal; accumulating, by the electronic apparatus, an anomaly determination count based on a steering control signal confirmed while driving on a straight road; and detecting, by the electronic apparatus, whether there is an anomaly in a lane following assistance system based on the accumulated anomaly determination count.

In addition, before the receiving a GPS signal, the method may further include checking and analyzing, by the electronic apparatus, image data about the front of the driving vehicle; and generating, by the electronic apparatus, the steering control signal to control steering of the vehicle based on the image data.

In addition, the method may further include detecting, by the electronic apparatus, an anomaly signal based on a change in the steering control signal.

In addition, the receiving a GPS signal may be a step of periodically checking the GPS signal when the anomaly signal is detected.

In addition, the accumulating an anomaly determination count may include continuously checking the steering control signal; detecting the anomaly signal based on a change in the confirmed steering control signal; and checking whether the anomaly signal is detected for a critical time or longer.

In addition, the accumulating an anomaly determination count may be a step of accumulating the anomaly determination count when the anomaly signal is detected for a critical time or longer while the vehicle is traveling on a straight road.

In addition, the detecting whether there is an anomaly in a lane following assistance system may be a step of determining that an anomaly is detected in the lane following assistance system when the anomaly determination count exceeds a threshold number.

In addition, the method may further include generating and outputting, by the electronic apparatus, a message notifying that an anomaly has occurred in the lane following assistance system.

In addition, the checking whether a road is straight may be a step of checking whether the road is straight by analyzing a slope between the GPS signal at the current time and the GPS signal at at least one previous time.

In addition, the detecting the anomaly signal based on a change in the confirmed steering control signal may be a step of detecting, by the electronic apparatus, as the anomaly signal a case in which as for an amplitude value for a change in the steering control signal, the maximum value of the amplitude is greater than or equal to a first threshold value and the minimum value of the amplitude is less than or equal to a second threshold value based on 0.

Furthermore, an electronic apparatus for detecting an anomaly in a lane following assistance system according to an embodiment of the present disclosure includes: a communicator configured to receive a GPS signal from a driving vehicle; and a controller configured to check whether a road on which the vehicle is driving is a straight road by analyzing the GPS signal, accumulate an anomaly determination count based on a steering control signal confirmed while the vehicle is driving on the straight road when the road is confirmed as a straight road, and detect whether there is an anomaly in a lane following assistance system based on the accumulated anomaly determination count.

In addition, the controller may be configured to check and analyze image data about the front of the driving vehicle, and generate the steering control signal to control steering of the vehicle based on the image data.

In addition, the controller may be configured to detect an anomaly signal based on a change in the steering control signal.

In addition, the controller may be configured to periodically check the GPS signal when the anomaly signal is detected.

In addition, the controller may be configured to continuously check the steering control signal, and check whether the anomaly signal detected due to a change in the steering control signal is detected for a critical time or longer.

In addition, the controller may be configured to accumulate the anomaly determination count when the anomaly signal is detected for a critical time or longer while the vehicle is traveling on a straight road.

In addition, the controller may be configured to determine that an anomaly is detected in the lane following assistance system when the anomaly determination count exceeds a threshold number.

In addition, the controller may be configured to generate a message notifying that an anomaly has occurred in the lane following assistance system.

In addition, the controller may be configured to check whether the road is straight by analyzing a slope between the GPS signal at the current time and the GPS signal at at least one previous time.

In addition, the controller may be configured to detect as the anomaly signal a case in which as for an amplitude value for a change in the steering control signal, the maximum value of the amplitude is greater than or equal to a first threshold value and the minimum value of the amplitude is less than or equal to a second threshold value based on 0.

As described above, the method and apparatus for detecting an anomaly in a lane following assistance system according to an embodiment of the present disclosure may provide a maintenance alarm before the user experiences inconvenience caused by an anomaly in the lane following assistance system by checking whether a road on which a vehicle is driving is straight based on a GPS signal and determining an anomaly in the lane following assistance system based on a steering angle obtained from a vehicle driving on a straight road.

### BRIEF DESCRIPTION OF THE DRAWINGS

FIG. 1 is a diagram showing the main configuration of an electronic apparatus configured to detect anomalies in a lane following assistance system according to an embodiment of the present disclosure.

FIG. 2 is a flowchart for describing a method for detecting an anomaly in a lane following assistance system according to an embodiment of the present disclosure.

FIG. 3 is a detailed flowchart for describing a method for detecting an anomaly according to an embodiment of the present disclosure.

FIG. 4 is a graph for describing a method for detecting an anomaly in a lane following assistance system according to an embodiment of the present disclosure.

### DETAILED DESCRIPTION OF THE EMBODIMENTS

Hereinafter, preferred embodiments according to the present disclosure will be described in detail with reference to the accompanying drawings. The detailed description to be disclosed hereinafter with the accompanying drawings is intended to describe exemplary embodiments of the present disclosure and is not intended to represent the only embodiments in which the present disclosure may be implemented. In the drawings, parts unrelated to the description may be omitted for clarity of description of the present disclosure, and like reference numerals may designate like elements throughout the specification.

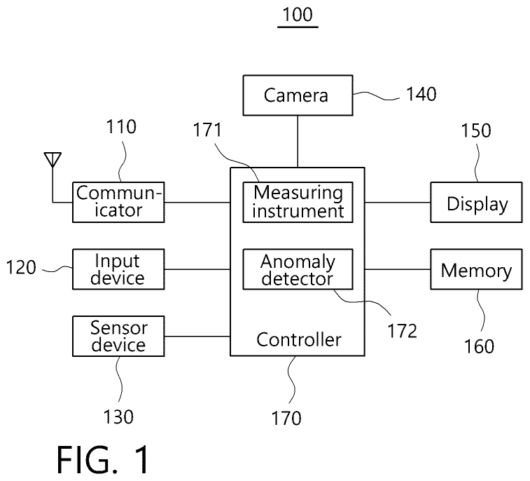

FIG. 1 is a diagram showing the main configuration of an electronic apparatus configured to detect anomalies in a lane following assistance system according to an embodiment of the present disclosure.

Referring to FIG. 1, the electronic apparatus 100 according to an embodiment of the present disclosure may include a communicator 110, an input device 120, a sensor device 130, a camera 140, a display 150, a memory 160, and a controller 170.

The communicator 110 may receive or provide sensing data obtained by the sensor device 130 and image data to the controller 170 through communication with the sensor device 130 and the camera 140. To this end, the communicator 110 may perform communication such as CAN (controller area network), NFC (near field communication), Zigbee, and the like, and may perform serial communication such as RS-232.

The input device 120 generates input data in response to input from a user or driver driving a vehicle. To this end, the input device 120 may include a key pad, a dome switch, a touch panel, a touch key, a button, and the like.

The sensor device 130 may include a steering sensor for sensing a steering angle. Based on this, the sensor device 130 may obtain the steering angle that is actually confirmed when the vehicle is traveling and provide it to the controller 170. To this end, the sensor device 130 may perform wireless communication such as Bluetooth, Bluetooth low energy (BLE), near field communication (NFC), Zigbee, and the like with the controller 170, and may perform serial communication such as RS-232.

The camera 140 is included or provided in the vehicle and generates image data about the environment outside the vehicle. In particular, the camera 140 may generate image data about the front of the running vehicle and provide it to the controller 170.

The display 150 displays display data related to an operation performed in the electronic apparatus 100. The display 150 includes, for instance, but not limited to, a liquid crystal display (LCD), a light emitting diode (LED) display, an organic light emitting diode (OLED) display, a micro electro mechanical systems (MEMS) display, and an electronic paper display. The display 150 may be integrated or combined with the input device 120 to be implemented as, for example, a touch screen capable of input.

The memory 160 stores an operation program for operation of the electronic apparatus 100. In particular, the memory 160 may store an algorithm for detecting an anomaly signal of the lane following assistance system based on a steering control signal or a steering angle identified when the vehicle is traveling, and may store an algorithm for checking whether the vehicle is traveling on a straight road to analyze a signal received from a GPS. The memory 160 may store an algorithm for checking whether there is an anomaly in the lane following assistance system from the detected anomaly signal.

The controller 170 may analyze the received GPS signal to check whether the road on which the vehicle is traveling is straight, and detect whether there is an anomaly in the lane following assistance system by accumulating an anomaly determination count based on the steering control signal or steering angle obtained when the vehicle is traveling on a straight road. For example, the controller 170 may count a number of changes in the control of the steering of the vehicle while the vehicle is driving on the straight road. To this end, the controller 170 may include a measuring instrument 171 and an anomaly detector 172. The controller 170 may comprise, for example, but not limited to, one or more of a circuit, a microprocessor, a semiconductor based microprocessor (in the form of a microchip or chip set), any hardware computer or processor. However, the controller 170 can be any hardware device.

The measuring instrument 171 checks whether the vehicle is traveling. When it is confirmed that the vehicle is traveling, the measuring instrument 171 checks whether the lane following assistance (LFA) system installed in the vehicle is activated. For example, the LFA may be activated at the same time that the vehicle's autonomous driving mode is activated.

If the LFA is not activated, the measuring instrument 171 checks the steering angle obtained from the steering sensor included in the sensor device 130. In addition, if the LFA is activated, the measuring instrument 171 analyzes image data about the front of the running vehicle obtained by the camera 140. The measuring instrument 171 generates a steering control signal to control the steering of the vehicle based on the analysis results of the image data. The measuring instrument 171 may provide a steering angle, indicating an angle of the steering of the vehicle, to the anomaly detector 172 when the LFA is not activated, and may provide a steering control signal for controlling the steering of the vehicle to the anomaly detector 172 when the LFA is activated.

The measuring instrument 171 analyzes the GPS signal when the anomaly detector 172 confirms that an anomaly signal of the LFA system is detected based on the steering control signal or steering angle. In this case, the measuring instrument 171 checks the slope between the GPS signal at the current time and the GPS signal at at least one previous time to determine whether the road on which the vehicle is currently traveling is a straight road.

When it is confirmed that the road on which the vehicle is currently traveling is a straight road, the measuring instrument 171 provides a signal indicating that the vehicle is traveling on the straight road to the anomaly detector 172.

The anomaly detector 172 checks whether an anomaly signal of the LFA system is detected based on the steering control signal or the steering angle provided by the measuring instrument 171. More specifically, if the maximum value of an amplitude for a change in the steering control signal or steering angle provided by the measuring instrument 171 is greater than or equal to a first threshold value and the minimum value of the amplitude for the change in the steering control signal or steering angle provided by the measuring instrument 171 is less than or equal to a second threshold value, the anomaly detector 172 may determine that an anomaly signal of the LFA system is detected. In this case, the first threshold value and the second threshold value may be set to be the same as or different from each other.

When an anomaly signal is detected based on the steering control signal or steering angle, the anomaly detector 172 outputs or provides a signal indicating that an anomaly signal has occurred to the measuring instrument 171 so that the measuring instrument 171 can analyze the GPS signal.

Subsequently, when a signal indicating that the road on which the vehicle is currently traveling is a straight road is received from the measuring instrument 171, the anomaly detector 172 continuously checks the steering control signal or the steering angle to check the change in the steering control signal or steering angle. The anomaly detector 172 accumulates one (1) or a predetermined value in the anomaly determination count when an anomaly signal identified from a change in the steering control signal or steering angle persists or has been generated for a critical time or longer. If the anomaly determination count exceeds a threshold (e.g. a predetermined value), the controller 170 determines that an anomaly has occurred in the LFA or an apparatus configured to control the steering of the vehicle. The controller 170 may generate a message notifying that an anomaly has occurred in the LFA or an apparatus configured to the steering of the vehicle and output the message on the display 150.

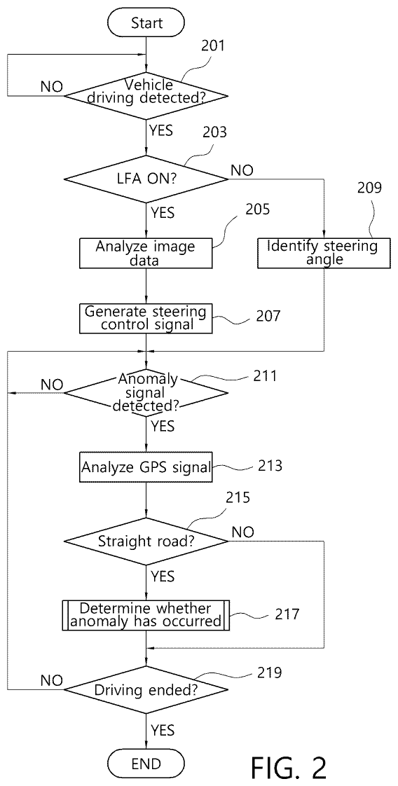

FIG. 2 is a flowchart for describing a method for detecting an anomaly in a lane following assistance system according to an embodiment of the present disclosure.

Referring to FIG. 2, in step 201, the controller 170 checks whether the vehicle is traveling. As a result of checking in step 201, when it is confirmed that the vehicle is traveling, the controller 170 performs step 203. In step 203, the controller 170 checks whether a lane following assistance system (LFA) included or provided in the vehicle is activated. For example, the lane following assistance system may be activated at the same time that the vehicle's autonomous driving mode is activated.

When it is determined that the LFA is activated as a result of checking in step 203, the controller 170 performs step 205, and when it is determined that the LFA is not activated as a result of checking in step 203, the controller 170 performs step 209. In step 209, the controller 170 checks the steering angle obtained by the steering sensor included in the sensor device 130 and performs step 211.

Conversely, in step 205, the controller 170 analyzes the image data of the front of the running vehicle obtained by the camera 140 and performs step 207. In step 207, the controller 170 generates a steering control signal to control the steering of the vehicle based on the analysis results of the image data.

In step 211, the controller 170 checks whether an anomaly signal of the LFA system is detected based on the steering control signal generated in step 207 or the steering angle identified in step 209. For instance, if the maximum value of an amplitude for a change in the steering control signal or steering angle is greater than or equal to a first threshold value and the minimum value of the amplitude for a change in the steering control signal or steering angle is less than or equal to a second threshold value, the controller 170 may determine that an anomaly signal in the LFA system is detected. The first threshold value and the second threshold value may be set to be identical to or different from each other.

The controller 170 analyzes the GPS signal in step 213. In this case, the controller 170 checks the slope between the GPS signal at the current time and the GPS signal at at least one previous time to determine whether the road on which the vehicle is currently traveling is a straight road.

In step 215, when it is confirmed that the road on which the vehicle is currently traveling is a straight road, the controller 170 performs step 217, and if the road on which the vehicle is currently traveling is not a straight road, the controller 170 performs step 219. In step 219, the controller 170 checks whether the driving of the vehicle is terminated, and ends the corresponding process if the driving of the vehicle is terminated. Conversely, if the end of the vehicle's traveling is not confirmed, the controller 170 may return to step 211 to perform steps 211 to 217 again.

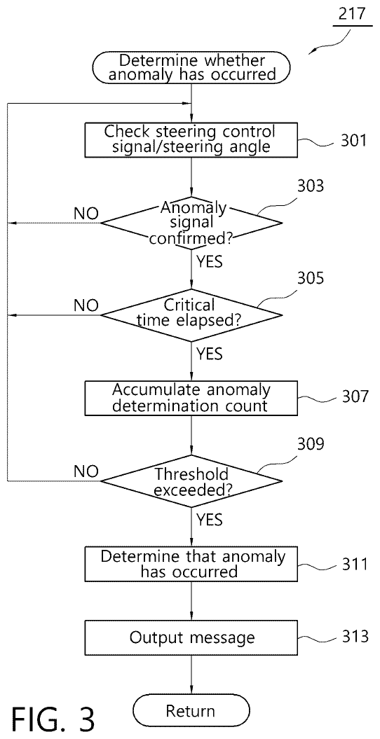

In step 217, the controller 170 determines whether an anomaly has occurred in the LFA or an apparatus configured to control the steering of the vehicle. This operation will be described in more detail with reference to FIG. 3 below.

FIG. 3 is a detailed flowchart for describing a method for detecting an anomaly according to an embodiment of the present disclosure.

Referring to FIG. 3, when it is confirmed or determined that an anomaly signal of the LFA system is detected in the steering control signal or steering angle, in step 301, the controller 170 continuously checks the steering control signal or steering angle to check a change in the steering control signal or steering angle. In step 303, when an anomaly signal is detected or confirmed from a change in the steering control signal or steering angle, the controller 170 performs step 305, and when an anomaly signal is not detected or confirmed, the controller 170 may return to step 301 to continuously check a change in the steering control signal or the steering angle.

In step 305, when an anomaly signal determined or identified from a change in the steering control signal or steering angle persists or has been generated for a critical time or longer, the controller 170 may perform step 307, and when the anomaly signal does not persist or has not been generated for a critical time or longer, the controller 170 may return to step 301 to continuously check a change in the steering control signal or the steering angle. In step 307, when an anomaly signal persists or has been generated for a critical time or longer, the controller 170 accumulates one (1) or a predetermined number in the anomaly determination count and performs step 309. In step 309, the controller may perform step 311 if the accumulated anomaly determination count exceeds the threshold, and return to step 301 if the accumulated anomaly determination count is not over the threshold.

In step 311, the controller 170 may determine that there is an anomaly in the LFA or an apparatus configured to control the steering of the vehicle and may perform step 313. In step 313, the controller 170 may generate a message notifying that an anomaly has occurred in the LFA or an apparatus that manages the steering of the vehicle and output the message on the display 150.

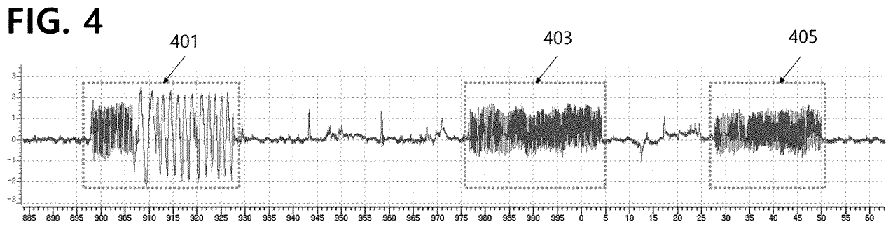

FIG. 4 is a graph for describing a method for detecting an anomaly in a lane following assistance system according to an embodiment of the present disclosure.

Referring to FIG. 4, the controller 170 may detect as an anomaly signal a state in which, as for the amplitude value for a change indicating the steering control signal of the running vehicle as shown in the reference numerals 401, 403, and 405, a case in which the maximum value of the amplitude is greater than or equal to a first threshold value and the minimum value of the amplitude is less than or equal to a second threshold value based on 0 persists for a critical time or longer. That is, a state of a case in which the amplitude value for the change indicated by the steering control signal is, for example, 2 or more persists for a critical time or longer may be detected as an anomaly signal.

For example, when an anomaly signal is first detected from the steering control signal, the controller 170 periodically checks the GPS signal from the time when the anomaly signal is first detected. The controller 170 determines whether the vehicle is traveling on a straight road by comparing a plurality of GPS signals. When the vehicle is traveling on a straight road, the controller 170 checks a change in the steering control signal as shown in FIG. 4. In this case, the x-axis of FIG. 4 represents time and the y-axis represents LFA torque overlay.

When it is confirmed that the steering control signal is an anomaly signal for a critical time as shown in the reference numeral 401, the controller 170 may add one (1) or a predetermined value to the anomaly determination count, and when it is confirmed that the steering control signal is an anomaly signal for a critical time as shown in the reference numeral 403, the controller 170 may additionally add one (1) or a predetermined value to the anomaly determination count. Subsequently, when it is confirmed that the steering control signal is an anomaly signal for a critical time as shown in the reference numeral 405, the controller 170 may additionally add one (1) or a predetermined value to the anomaly determination count.

As shown in FIG. 4, when the determination count accumulated for a critical time, for example, 15 seconds or more exceeds the threshold, for example, 3, the controller 170 may determine that an anomaly has occurred in the LFA.

In addition, although FIG. 4 describes as an example whether an anomaly has occurred in the LFA based on the steering control signal, it is not necessarily limited to this, and it can be changed and applied to determine whether an anomaly has occurred in an apparatus that manages the steering of the vehicle based on the steering angle. Through this, the present disclosure may determine whether there is an anomaly in an apparatus that manages steering of a vehicle even when the autonomous driving mode of the vehicle is in an inactive state.

The embodiments of the present disclosure disclosed in the present specification and drawings are only provided as specific examples to easily describe the technical content of the present disclosure and to aid understanding of the present disclosure, and are not intended to limit the scope of the present disclosure. Therefore, the scope of the present disclosure should be construed that all changes or modifications derived based on the technical idea of the present disclosure in addition to the embodiments disclosed herein are included in the scope of the present disclosure.

What is claimed is:

1. A method for detecting an anomaly in a lane following assistance system, comprising:
receiving a GPS signal of a vehicle;
determining whether the vehicle is driving on a straight road based on the GPS signal of the vehicle;
counting a number of changes in control of steering of the vehicle while the vehicle is driving on the straight road; and
detecting an anomaly in a lane following assistance system based on the number of changes in the control of the steering of the vehicle counted while the vehicle is driving on the straight road.

2. The method according to claim 1, further comprising, before the receiving of the GPS signal of the vehicle, generating a steering control signal for the control of the steering of the vehicle based on image data in front of the vehicle,
wherein the counting of the number of changes in the control of the steering of the vehicle while the vehicle is driving on the straight road comprises counting the number of changes in the control of the steering of the vehicle using the steering control signal.

3. The method according to claim 2,
further comprising detecting an anomaly signal of the lane following assistance system based on a change in the steering control signal.

4. The method according to claim 3, wherein the receiving of the GPS signal of the vehicle comprises periodically checking the GPS signal of the vehicle when the anomaly signal of the lane following assistance system is detected.

5. The method according to claim 4, wherein the counting of the number of changes in the control of the steering of the vehicle while the vehicle is driving on the straight road comprises:
checking the steering control signal;
detecting the anomaly signal of the lane following assistance system based on the change in the steering control signal; and
checking whether the anomaly signal of the lane following assistance system is detected for a reference time or longer.

6. The method according to claim 5, wherein the counting of the number of changes in the control of the steering of the vehicle while the vehicle is driving on the straight road comprises counting the number of changes in the control of the steering of the vehicle when the anomaly signal of the lane following assistance system is detected for the reference time or longer while the vehicle is traveling on the straight road.

7. The method according to claim 6,
wherein the detecting of the anomaly in the lane following assistance system comprises, when the counted number of changes in the control of the steering of the vehicle exceeds a threshold number, determining that the anomaly is detected in the lane following assistance system.

8. The method according to claim 7, further comprising:
outputting a message for notifying that the anomaly has occurred in the lane following assistance system.

9. The method according to claim 1, wherein the determining of whether the vehicle is driving on the straight road comprises analyzing a slope between the GPS signal of the vehicle at a current time and the GPS signal of the vehicle at at least one previous time to determine whether the vehicle is driving on the straight road.

10. The method according to claim 4, wherein the detecting of the anomaly signal of the lane following assistance system based on the change in the steering control signal comprises determining that the anomaly signal of the lane following assistance system is detected when a maximum value of an amplitude of the change in the steering control signal is greater than or equal to a first threshold value and a minimum value of the amplitude of the change in the steering control signal is less than or equal to a second threshold value.

11. An electronic apparatus for detecting an anomaly in a lane following assistance system, comprising:
a controller configured to determine whether a vehicle is driving on a straight road based a GPS signal of the vehicle, count a number of changes in control of steering of the vehicle while the vehicle is driving on the straight road, and detect an anomaly in a lane following assistance system based on the number of changes in the control of the steering of the vehicle counted while the vehicle is driving on the straight road.

12. The electronic apparatus according to claim 11, wherein:
the controller is configured to generate a steering control signal for the control of the steering of the vehicle based on image data in front of the vehicle, and
the number of changes in the control of the steering of the vehicle is counted using the steering control signal by the controller.

13. The electronic apparatus according to claim 12, wherein the controller is configured to detect an anomaly signal of the lane following assistance system based on a change in the steering control signal.

14. The electronic apparatus according to claim 13, wherein the controller is configured to periodically check the GPS signal of the vehicle when the anomaly signal of the lane following assistance system is detected.

15. The electronic apparatus according to claim 14, wherein the controller is configured to:
check the steering control signal, and
check whether the anomaly signal of the lane following assistance system detected based on the change in the steering control signal is detected for a reference time or longer.

16. The electronic apparatus according to claim 15, wherein the controller is configured to count the number of changes in the control of the steering of the vehicle when the anomaly signal of the lane following assistance system is detected for the reference time or longer while the vehicle is traveling on the straight road.

17. The electronic apparatus according to claim 16, wherein the controller is configured to, when the counted number of changes in the control of the steering of the vehicle exceeds a threshold number, determine that the anomaly is detected in the lane following assistance system.

18. The electronic apparatus according to claim 17, wherein the controller is configured to output a message for notifying that the anomaly has occurred in the lane following assistance system.

19. The electronic apparatus according to claim 11, wherein the controller is configured to analyze a slope between the GPS signal of the vehicle at a current time and the GPS signal of the vehicle at at least one previous time to determine whether the vehicle is driving on the straight road.

20. The electronic apparatus according to claim 14, wherein the controller is configured to determine that the anomaly signal of the lane following assistance system is detected when a maximum value of an amplitude of the change in the steering control signal is greater than or equal to a first threshold value and a minimum value of the amplitude of the change in the steering control signal is less than or equal to a second threshold value.
